(19) United States
(12) Patent Application Publication
(10) Pub. No.: US 2007/0003097 A1
(43) Pub. Date: Jan. 4, 2007

(54) Angularly adjustable speaker system

(75) Inventors: Eric Aaron Langberg, Milford, PA (US); Eran Schul, Milford, PA (US)

Correspondence Address: GREENBERG-TRAURIG, 1750 TYSONS BOULEVARD, 12TH FLOOR, MCLEAN, VA, 22102, US

(73) Assignee: Altec Lansing Technologies, Inc., Milford, PA (US)

(21) Appl. No.: 11/218,117

(22) Filed: Sep. 2, 2005

Related U.S. Application Data
(60) Provisional application No. 60/694,992, filed on Jun. 30, 2005.

(51) Int. Cl. H04R 1/02

(52) U.S. Cl. 381/386

(57) ABSTRACT

A loudspeaker system includes a support base having a first speaker driver mounted thereto, the first speaker driver being adapted to reproduce sound across a first frequency band. The system further includes a speaker housing having at least one second speaker driver mounted therein, the second speaker driver being adapted to reproduce sound across a second frequency band, the high end of the second frequency band being higher than the high end of the first frequency band. A hinged connection is provided between the support base and the speaker housing, whereby the speaker housing can be vertically pivoted about a generally horizontal axis.

This application claims priority to provisional application Ser. No. 60/694,992 filed Jun. 30, 2005, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of loudspeakers, and in particular to a loudspeaker having an angularly-adjustable speaker housing.

### BACKGROUND OF THE INVENTION

Loudspeaker systems having a subwoofer and two or more satellite speakers are known and used in the art for providing accurate reproduction of audio signals over a wide frequency range. In such systems, a crossover is typically used to split the audio signal such that its low frequency component is directed to the subwoofer and midrange and high frequency components are directed to the satellite speakers. Because low-frequency sound is relatively non-directional as perceived by the human ear, placement of the subwoofer with respect to the listener's ears is relatively non-critical.

Placement of satellite speakers, which reproduce the relatively directional mid- and high-frequency components, with respect to the listener's ears is more critical for accurate stereo imaging and reproduction of the audio signals as perceived by the listener. However, such speakers typically require physical movement of the entire speaker in order to direct the sound projected from the speaker directly toward a listener's ears.

One solution is taught in commonly owned U.S. Pat. No. 4,884,655 to Freadman et al. entitled Tower-Type Speaker Cabinet With Pivoted Plural Speaker Subassembly. Freadman et al. teach a tower-type speaker cabinet with a center subcabinet and pivot means supporting the subcabinet such that it can be swiveled horizontally about a range of movement through predetermined angles about a vertical axis.

Stereo desktop speakers are well known for reproducing audio signals from various sources such as computers and portable media players. Such speakers typically sit flat on a desk surface such that they direct sound toward a listener's waist when the listener is sitting and direct sound even lower when the listener is standing. Thus, the listener typically does not perceive the full volume and most accurate stereo image available from the speakers.

### SUMMARY OF THE INVENTION

Accordingly, the present invention is directed to an angle-adjustable loudspeaker system that substantially obviates one or more of the problems due to limitations and disadvantages of the related art.

In one embodiment, the invention provides a loudspeaker system including a support base having a first speaker driver mounted thereto, the first speaker driver being adapted to reproduce sound across a first frequency band. The system further includes a speaker housing having at least one second speaker driver mounted therein, the second speaker driver being adapted to reproduce sound across a second frequency band, the high end of the second frequency band being higher than the high end of the first frequency band. A hinged connection is provided between the support base and the speaker housing, whereby the speaker housing can be vertically pivoted about a generally horizontal axis.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a front perspective view illustrating components of the invention according to one embodiment.

### DETAILED DESCRIPTION OF THE PREFERRED EMBODIMENT

Reference will now be made in detail to illustrative embodiments of the present invention, examples of which are shown in the accompanying drawings.

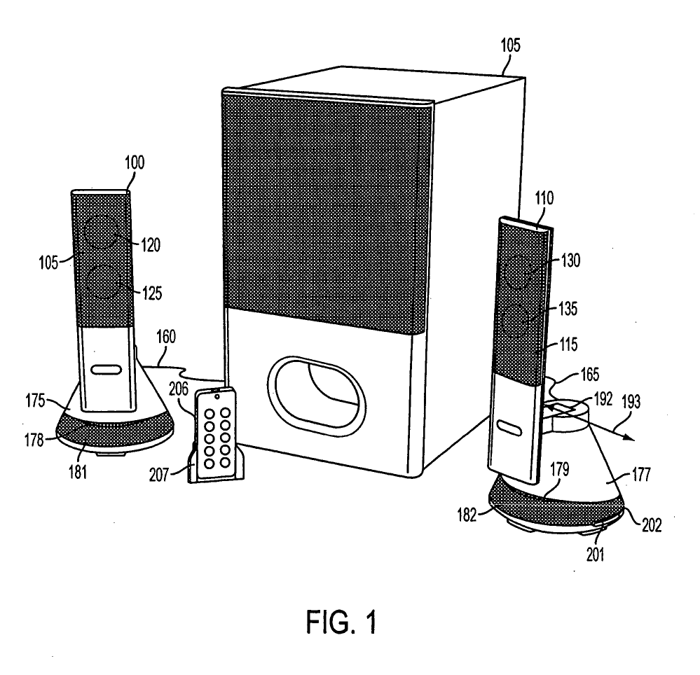

Referring to FIG. 1, a speaker system in accordance with one embodiment of the present invention includes left and right satellite speaker housings 100, 110 and a subwoofer component 105. The speaker system may be connected to any type of audio source, such as a gaming system, personal computer, portable media player, stereo receiver, or other audio source known to one of ordinary skill in the art, or may be integrated into a portable media reproduction system such as that shown in U.S. patent application Ser. No. 10/836,113 filed Apr. 30, 2004, the entire disclosure of which is incorporated herein by reference. The speaker housings 100, 110 may be positioned on a desk or shelf, mounted on a wall, or any other known configuration of positioning loudspeakers.

The speaker housings 100, 110 have loudspeaker drivers 120, 125, 130, 135 positioned on a front surface 105, 115 of the speaker housings 100, 110. The loudspeaker drivers 120, 125, 130, 135 may be, e.g., 28 mm full-range micro drivers. Although this exemplary embodiment has two drivers in each speaker housing, any number of drivers and speaker housings may be used, as appreciated by one of ordinary skill. The subwoofer 105 may be, e.g., a 6.5-inch long-throw woofer capable of handling 19 watts at 8 ohms that reproduces sound in the frequency range of 40 Hz to 160 Hz. In one embodiment, the housing of the subwoofer 105 encloses an audio amplifier (not shown).

Left and right support bases 175, 177 are provided to support the left and right speaker housings 100, 110, respectively, each including a flat bottom, and/or feet, which rests upon a support surface such as a desktop or shelf. For each speaker housing and its associated base, this support is provided via a hinged connection 192 between the speaker housing 110 and the support base 177. This hinged connection 192 permits angular adjustment of the speaker housing 110 with respect to the support base 177 such that the direction of projection of sound from the drivers 120, 125, 130, 135 can be adjusted vertically over an angle of approximately 45 degrees.

In this manner, the angle of the speaker housing 110 can be adjusted vertically about a horizontal axis 193 such that the direction of projection of sound from the drivers 120, 125, 130, 135 is generally toward the listener's ears. Thus, the speaker system of the invention is able to maximize the volume of acoustic energy actually received by the listener's ears for a given level of acoustic output from the speakers. This maximization is particularly advantageous in applications where persons other than the listener are in listening range of the speakers and would be disturbed by louder volume levels projecting therefrom. Such applications include, e.g., speaker systems for use at computer workstations in office buildings with multiple offices or cubicles in close proximity, and speaker systems for use with home computers that are used for video games where persons other than the game player would be disturbed by louder volume levels projecting from the drivers 120, 125, 130, 135. This vertical adjustability about a horizontal axis further provides a means to maximize the stereo imaging of the sound from the drivers 120, 125, 130, 135 as perceived by the listener.

The left and right support bases 175, 177 each include a down-firing mid-bass driver 178, 179 behind left and right speaker grills 181, 182. The down-firing mid-bass drivers 178, 179 may be, e.g., 3″ mid-bass drivers, the frequency range of which has an upper limit that is lower than the upper limit of the frequency range of the drivers 120, 125, 130, 135. The down-firing mid-bass drivers 178, 179 together with the drivers 120, 125, 130, 135 reproduce sound in a frequency range of, e.g., 160 Hz to 20 kHz. In one embodiment, the left and right support bases 175, 177 are in ported enclosures. A port in the enclosure (not shown) may be directed through porting chamber to an opening. In one embodiment, the porting chamber is formed out of or within a the hinged connection 192. In one embodiment, the porting chamber is formed from or directed through the hinged connection 192 and opens through the a face of the speaker housing 110 such that the direction of projection of sound through the port is generally toward the listener's ears.

Left and right cables 160, 165 are provided to connect the speaker support bases 175, 177, respectively, with the subwoofer 105, which is connected to the audio source. The housing of the subwoofer 105 preferably encloses an audio amplifier with gain adjustment (not shown) so that the speaker system can be driven by a line level input from an audio device such as a PC soundcard or portable media player. The housing of the subwoofer 105 further encloses a crossover (not shown) which, for each of the left and right audio channels, splits out the mid-bass to higher-frequency component of the audio signal from the audio source and sends those components to the respective satellites for reproduction by the drivers 120, 125, 130, 135 and the down-firing mid-bass drivers 178, 179. Each of the support bases 175, 177 may include a second crossover for splitting that component into separate mid-bass and higher-frequency components to respectively drive the drivers and the down-firing mid-bass drivers.

The left cable 160 or the right cable 165 may include extra wire conductors to separately conduct a gain control signal from a volume control 201 mounted on one of the support bases 177 to the amplifier within the housing of the subwoofer 105. The left cable 160 or the right cable 165 may further include extra wire conductors to separately conduct a stereo audio signal from the amplifier within the housing of the subwoofer 105 to a headphone jack 202 mounted on one of the support bases 177. An infrared or RF wireless remote control 206 may be provided for remote control of volume, treble, bass, loudness, or other function. A mounting bracket 207 may be provided for temporary storage of the wireless remote control 206 when not in use, the mounting bracket 207 being mountable on a flat surface convenient to the listener. A receiver for the receiving and decoding the infrared or RF signal transmitted by the wireless remote control 206 may be provided, e.g., on one of the satellite speakers housings 100, 110 or on the enclosure of the subwoofer 105.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A loudspeaker system, comprising:
a support base having a first speaker driver mounted thereto, the first speaker driver being adapted to reproduce sound across a first frequency band;
a speaker housing having at least a second speaker driver mounted thereto, the second speaker driver being adapted to reproduce sound across a second frequency band, the high end of the second frequency band being higher than the high end of the first frequency band;
a hinged connection between the support base and the speaker housing, whereby the speaker housing can be pivoted about a generally horizontal axis.

2. The loudspeaker system in accordance with claim 1, wherein the first speaker driver is a down-firing mid-bass driver and the first frequency band is a mid-bass frequency band.

3. The loudspeaker system in accordance with claim 1, wherein the low end of the second frequency band is higher than the low end of the first frequency band, and lower than the high end of the first frequency band.

4. The loudspeaker system in accordance with claim 1, further comprising:
a subwoofer for reproduction of bass frequencies.

5. The loudspeaker system in accordance with claim 4, further comprising a cabinet enclosing the subwoofer, and wherein the cabinet encloses an audio amplifier.

6. The loudspeaker system in accordance with claim 1, wherein the support base forms an enclosure having an opening, and wherein the first speaker driver is mounted in and to the opening.

7. The loudspeaker system in accordance with claim 6, further comprising a port opening in the enclosure for porting the first speaker driver.

8. The loudspeaker system in accordance with claim 7, further comprising a porting chamber having a proximal and a distal opening, the proximal opening of the porting chamber being operatively engaged with the port opening.

9. The loudspeaker system in accordance with claim 8, wherein the distal opening of the porting chamber is adapted to be movable in relation to the support base.

10. The loudspeaker system in accordance with claim 9, wherein the distal opening of the porting chamber is operatively engaged with the speaker housing and moves in relation to the support base in response to the speaker housing being pivoted about the generally horizontal axis.

11. The loudspeaker system in accordance with claim 10, wherein the speaker housing has a front face, and the distal opening of the porting chamber is operatively opened through an opening in the front face.

12. A loudspeaker system, comprising:
a support base having a resting surface for resting on a support surface and having a down-firing speaker driver mounted thereto, the down-firing speaker driver being mounted to the support base at an angle of less than about 20 degrees with respect to the support surface when the resting surface is resting on the support surface, the down-firing speaker driver being adapted to reproduce sound across a first frequency band;
a speaker housing having at least a second speaker driver mounted thereto, the second speaker driver being adapted to reproduce sound across a second frequency band, the high end of the second frequency band being higher than the high end of the first frequency band;
a movable connection between the support base and the speaker housing, whereby the speaker housing can be moved in orientation with respect to the support base.

13. The loudspeaker system in accordance with claim 12, further comprising a crossover for attenuating at least a first range of frequencies of an audio signal to produce a first bandwidth limited signal, and for attenuating at least a second range of frequencies of the audio signal to produce a second bandwith limited signal, and wherein the first bandwith limited signal is directed to the down-firing speaker driver and the second bandwith limited signal is directed to the second speaker driver.

14. The loudspeaker system in accordance with claim 12, wherein the resting surface comprises feet for resting upon the support surface.

15. The loudspeaker system in accordance with claim 12, wherein the down-firing speaker driver comprises a mid-bass driver and the first frequency band is a mid-bass frequency band.

16. The loudspeaker system in accordance with claim 6, wherein the support base forms an enclosure having an opening, and wherein the down-firing speaker driver is mounted in and to the opening.

17. The loudspeaker system in accordance with claim 16, further comprising a port opening in the enclosure for porting the first speaker driver.

18. The loudspeaker system in accordance with claim 17, further comprising a porting chamber having a proximal and a distal opening, the proximal opening of the porting chamber being operatively engaged with the port opening, and the distal opening of the porting chamber being adapted to be movable in relation to the support base.

19. The loudspeaker system in accordance with claim 18, wherein the distal opening of the porting chamber is operatively engaged with the speaker housing and moves in relation to the support base in response to the speaker housing being moved in orientation with respect to the support base.

20. The loudspeaker system in accordance with claim 19, wherein the speaker housing has a front face, and the distal opening of the porting chamber is operatively opened through an opening in the front face.
